(19) United States
(12) Patent Application Publication
(10) Pub. No.: US 2007/0131251 A1
(43) Pub. Date: Jun. 14, 2007

(54) Device and method for cleaning a thick matter delivery pipe

(75) Inventors: Ernst Murthum, Leinfelden-Echterdingen (DE); Klaus Buhrer, Filderstadt (DE); Volker Wehner, Rottenburg (DE)

Correspondence Address: AKERMAN SENTERFITT, P.O. BOX 3188, WEST PALM BEACH, FL, 33402-3188, US

(73) Assignee: PUTZMEISTER Aktiengesellschaft, Aichtal (DE)

(21) Appl. No.: 10/594,409

(22) PCT Filed: Mar. 18, 2005
(86) PCT No.: PCT/EP05/02897

§ 371 Date: Sep. 26, 2006

(30) Foreign Application Priority Data
Mar. 26, 2004 (DE) 10 2004 015 417.1

(51) Int. Cl. B08B 9/00; B08B 9/027; B08B 3/00

(52) U.S. Cl. 134/22.1; 134/166 R; 134/169 C; 134/22.11

(57) ABSTRACT

The invention relates to a device for cleaning a thick matter delivery pipe (10), comprising an end-hose (18) which is mounted on an outlet side, a device (24) for introducing a pressurised fluid into the thick matter delivery pipe (10), and a cleaning body (22) that can be driven through the delivery pipe (10) by the fluid, said cleaning body lying against the entire circumference of the inner surface of the thick matter delivery pipe (10). According to the invention, the device comprises a sensor (26) for determining the consistency of the material in a section of the thick matter delivery pipe (10), a control unit (28) to which a signal can be transmitted from the sensor (26) upon a change in the consistency of the material, and a closing device (30) that can be actuated by the control unit when the signal is received, the closing device being used to at least partially close the end-hose (18).

### CROSS REFERENCE TO RELATED APPLICATION

This application is a national stage of PCT/EP2005/002897 filed Mar. 18, 2005 and based upon DE 10 2004 015 417.1 filed Mar. 26, 2004 under the International Convention.

### BACKGROUND OF THE INVENTION

1. Field of the Invention

The invention concerns a device for cleaning a thick matter delivery pipe, a process for cleaning a thick matter delivery pipe, as well as a squeeze valve that can be inserted onto a flexible delivery pipe.

2. Description of Related Art

Thick matter such as concrete is delivered to a construction site in that it is pumped by means of a thick matter pump from a material supply container through a thick matter delivery pipe extending all the way to the construction site. Following utilization of the pump, the delivery pipe must be emptied of the residual material remaining therein and cleaned. The residual material can be pumped back to the material supply container. This however has the disadvantage, that the returned concrete can no longer be employed and must be disposed of. In the case of long thick matter delivery pipes, there is the additional problem that the material supply container can run over. For this reason in most cases a cleaning body, such as for example a ball sponge, is introduced at the inlet side of the thick matter conveyor pipe. The sponge ball lies with its entire outer circumference against the inner surface of the thick matter delivery pipe and is advanced through the thick matter delivery pipe until the end by application of air or water under pressure. At this time, it pushes the residual material remaining in the thick matter delivery pipe ahead of it and presses it out of the outlet side of the end-hose.

The use of water as pressure medium has the disadvantage, that the residual concrete is diluted by the water and thus cannot be used. Acting upon the sponge ball with compressed air requires, for safety reasons, a capturing device at the outlet, which prevents the sponge ball causing damage after expulsion out of the end-hose. The capturing device is removed when the pump is in operation and is only attached during the cleaning operation. It's assembly and disassembly is inconvenient and laborious in large applications, such as, for example, mobile concrete pumps.

### SUMMARY OF THE INVENTION

It is thus the task of the invention to improve a device and a process of the above-described type in such a manner that the cleaning of the thick matter delivery pipe requires less time and effort.

The inventive solution is based upon the idea, that the cleaning body is captured in the end-hose by the at least partial closing of the end-hose, after the majority of the residual material has already been removed from the thick matter delivery pipe. For this purpose, a sensor detects a change in consistency of the material in a section of the thick matter delivery pipe as the cleaning body reaches this section. This can occur thereby, that the sensor recognizes the arrival of the cleaning body in the section of the delivery pipe. A further, simple method is comprised therein, that the sensor recognizes whether it is primarily thick matter or primarily fluid that is located in this section of the thick matter delivery pipe. The sensor recognizes the passage-through of the cleaning body through this section by detecting that the consistency of the material contained in the section changes: first, thick matter such as concrete is contained in this section, then after passage-through of the cleaning body, fluid is contained.

In principle it is possible to use water as the fluid, wherein a water pump is employed for conveying the water. It is however preferred that air is employed as the fluid and that the device for introduction of the fluid is a compressor for producing compressed air. Thereby it is prevented that the residual concrete remaining in the thick matter delivery pipe is diluted. The residual concrete can then, in large part, be reused and need not be disposed of, which can be expensive.

The sensor is preferably an ultrasound sensor adapted to transmit ultrasound into the thick matter delivery pipe. Ultrasound signals reflected from the inner wall of the thick matter delivery pipe allow the calibrated sensor to determine the consistency of the material located in the pipe-line. Therein the sensor is preferably calibrated for recognition of at least two different material consistencies. These could be, for example, the material pairs “thick matter/fluid”, “thick matter/cleaning body” or “fluid/cleaning body”. The cleaning body is preferably comprised of a compressible material. It is preferably introduced via a slide valve located at the inlet side of the thick matter delivery pipe.

It is preferred that the end-hose includes a jacket pipe of elastomeric material, preferably of rubber, and that the closable opening includes a squeeze valve for narrowing the internal width or for closure of the end-hose. If the end-hose is closed, then a part of the residual concrete can be retained therein. It is particularly preferable when the inner width of the end-hose is only narrowed, so that the cleaning body remains trapped, however, the largest portion of the residual material can be squeezed out of the end-hose through the narrowed opening, which expelled concrete can then still be used.

The squeeze valve serves for the rapid closure of the end-hose upon interruption of the pumping process. Thereby, an uncontrolled emission of concrete out of the end-hose is prevented and the environment is protected. This squeeze valve, which is the preferred closure device for the inventive device for cleaning a thick matter delivery pipe, is characterized thereby, that it can be introduced essentially upon any desired flexible pipeline, in particular an end-hose of the thick matter delivery pipe. It is thus not subjected to friction by action of the thick matter conveyed through the pipeline. Further, it has no rigid components which could present a danger of injury, with the exception of the valve.

The hose has on its outer side, opposite to the hollow inner space, a covering of a textile fabric layer. Further, it is advantageous when it is embedded in a sleeve of elastomeric material. The sleeve likewise preferably surrounds the jacket. This imparts an increased shape stability to the squeeze valve. The sleeve preferably has the shape of a hollow cylinder. Therein, the inner diameter must be as large as the outer diameter of the likewise cylindrically shaped pipeline. The jacket is preferably comprised of a preferably multi-layered textile fabric. In the inlet and the outlet opening a valve is preferably provided, so that the hollow space can be easily filled with gas and thereafter be emptied.

### BRIEF DESCRIPTION OF THE DRAWINGS

In the following the invention will be described in greater detail on a basis of illustrative examples represented schematically in the figure. There is shown in:

FIG. 1 a diagrammatic representation of a device for cleaning a thick matter delivery pipe;

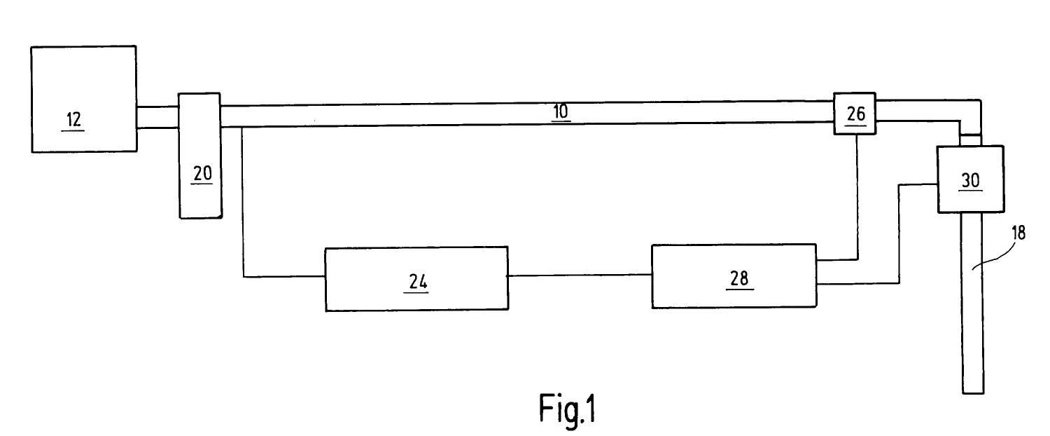

FIG. 2 a perspective representation of an end-hose of the thick matter delivery pipe with the device according to FIG. 1; and

FIG. 3 a sectional representation of a squeeze valve.

### DETAILED DESCRIPTION OF THE INVENTION

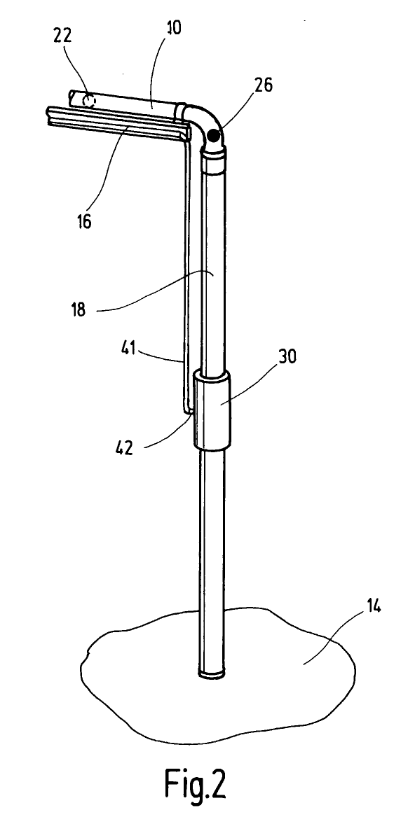

The thick matter delivery pipe 10 is designed to convey thick matter, such as concrete, from a material supply container 12 to a construction site 14. It is mounted on a boom, of which the end section of a boom arm 16 is show in FIG. 2, and carries on its outlet end a rubber end-hose 18. For cleaning after the pumping process, a cleaning body 22 in the form of a compressible sponge ball, lying with its outer diameter against the inner wall of the thick matter delivery pipe 10, is introduced into the inlet via a slide valve 20. At the same time, the slide valve 20 blocks the thick matter conveyor pipe 10 towards the material supply container 12. By means of a compressor 24, compressed air is introduced into the thick matter delivery pipe, which pushes the sponge ball 22 through the thick matter delivery pipe 10 in the direction of the end-hose 18. The residual concrete remaining in the thick matter delivery pipe 10 is thereby removed out the end-hose 18 by the sponge ball 22. In one section of the thick matter delivery pipe 10, close to the end-hose 18, an ultrasound sensor 26 is provided, which the inner wall of the thick matter delivery pipe 10 impinges with ultrasound. The ultrasound reflected from the inner wall and measured by the sensor 26 experiences a change, when the consistency of the material located in the section of the thick matter delivery pipe 10 carrying the sensor changes. This is the case, when the sponge ball 22 passes the sensor 26. The sponge ball 22 pushes the residual concrete ahead of it as a column; behind the sponge ball 22, there is primarily compressed air. The change in consistency measured by the sensor 26 from concrete to air is recognized by the sensor, which transmits a signal to the control unit 28.

The end-hose 18 carries a squeeze value 30, which upon actuation narrows or closes its inner cross-section. The squeeze valve 30 is actuated by the control unit 28, when the control unit obtains a signal from the sensor 26 characterizing a change in consistency. The sponge ball 22 remains hanging in the narrowed side of the end-hose 18, while the residual concrete pushed ahead of the sponge ball 22 can still pass through this location and be reused. Simultaneously, with the actuation of the squeeze valve 30, the control unit 28 switches off the compressor 24. For removal of the sponge ball 22 from the end-hose 18, the squeeze valve 30 is de-tensioned and the thick matter delivery pipe 10 is once again acted upon with compressed air.

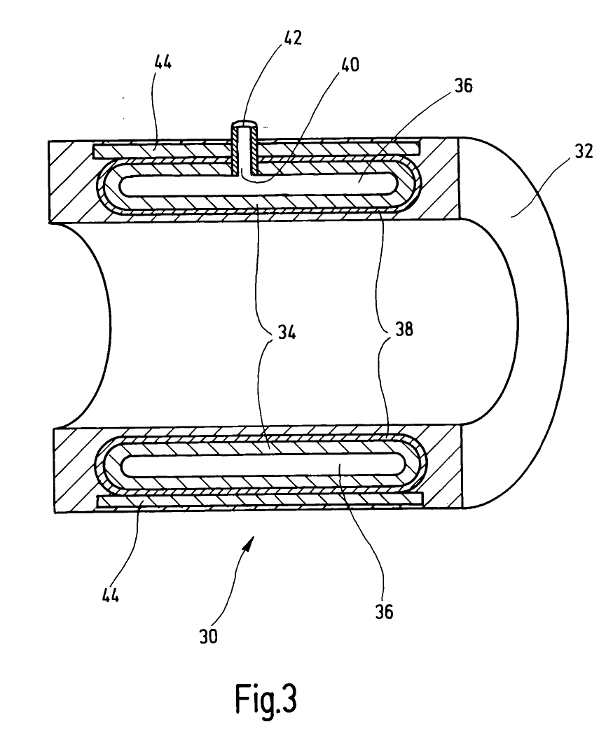

The inventive squeeze valve (FIG. 3) exhibits a sleeve 32 of an elastomeric material. The sleeve 32 is cylindrical in shape and has an inner diameter, which is somewhat larger than the outer diameter of the end-hose 18, so that the squeeze valve 30 can be slid thereupon. In the sleeve 32 a hose 34 of an elastomeric material is embedded, which borders the ring-shaped hollow space 35. The hose 34 is covered on its outer side with a textile fabric layer 38. It further exhibits an opening 40, via which it can be filled with gas, in particular compressed air, via a line 41 (FIG. 2). In the inlet/outlet opening 40 a valve 42 is provided. In the sleeve 32 a ring-shaped jacket 44 is embedded, in the inside of which the hose 34 is situated. The jacket 44 is comprised of multiple layers of a textile fabric and is, for this reason, more difficult to deform than the textile fabric layer 38. Upon actuation of the squeeze valve, compressed air is introduced via the valve 42 into the hollow space 36, so that the hose 34 can be narrowed. The jacket 44 constricts the diameter of the hose 34 in the radially inwards from the outside, so that the filling of the hollow space 36 with compressed air brings about a narrowing of the inner diameter of the sleeve 32. This narrowing is transmitted onto the flexible end-hose 18 passing through the sleeve 32, so that upon actuation of the squeeze valve 30 it's narrow width can be narrowed or as the case may be the end-hose 18 then can be closed off.

In summary the following can be concluded: The invention relates to a device for cleaning a thick matter delivery pipe 10, comprising an end-hose 18 which is mounted on an outlet side and is provided with a device 24 for introducing a pressurised fluid into the thick matter delivery pipe 10, and a cleaning body 22 that can be driven through the delivery pipe 10 by a fluid, an entire circumference of said cleaning body lying against the inner surface of the thick matter delivery pipe 10. According to the invention, the device comprises a sensor 26 for determining the consistency of the material in a section of the thick matter delivery pipe 10, a control unit 28 to which a signal can be transmitted from the sensor 26 in the case of a change in the consistency of the material, and a closing device 30 that can be actuated by the control unit when a signal is received and which is used to at least partially close the end-hose 18.

1-22. (canceled)

23. A device for cleaning a thick matter delivery pipe (10) having
an end-hose (18), the end-hose (18) including a jacket pipe of elastomeric material,
a cleaning body (20) which with a full circumference lies against the inner surface of the thick matter delivery pipe (10),
a device (24) for introduction of a fluid under pressure into the thick matter delivery pipe (10) for acting on the cleaning body (22) and transporting the cleaning body through the delivery pipe,
a closure device (30) for the at least partial closure of the end-hose (18), and
a sensor (26) determining the consistency of the material situated in a section of the thick matter delivery pipe (10) and for transmitting a signal characterizing a change in consistency to a control unit (28) for actuation of the a closure device (30),
wherein the a closure device (30) is a squeeze valve for narrowing the internal width of or for closing the end-hose (18).

24. The device according to claim 23, wherein said elastomeric material is rubber.

25. The device according to claim 23, wherein the fluid is air and wherein the device (24) for introduction of the fluid is a compressor for producing compressed air.

26. The device according to claim 23, wherein the fluid is water and wherein the device (24) for introduction of the fluid is a water pump.

27. The device according to claim 23, wherein a slide valve (20) is provided on the inlet side of the thick matter delivery pipe (10) for introduction or insertion of the cleaning body (22).

28. The device according to claim 23, wherein the sensor (26) is calibrated for recognition of least two different material consistencies.

29. The device according to claim 23, wherein the sensor (26) is a ultrasound sensor emitting ultrasound into the thick matter delivery pipe (10).

30. The device according to claim 23, wherein the cleaning body (22) is comprised of a compressible material.

31. A process for cleaning a thick matter delivery pipe (10) with an end-hose (18) provided on the outlet side, the end-hose (18) including a jacket pipe of elastomeric material, said method comprising
introducing fluid under pressure into the thick matter delivery pipe (10) to convey a cleaning body (22) through the pipe under the influence of the fluid, wherein the cleaning body is fully circumferentially in contact with the inner diameter of the thick matter delivery pipe (10),
determining the consistency of the material located in a section of the thick matter delivery pipe (10) via a sensor (26),
wherein a change in the consistency of the material causes the sensor (26) to transmit a signal to the control unit (28), and
wherein the control unit (28) actuates a closure device (30) upon receiving this signal, as a result of which actuation the end-hose (18) is narrowed or the end-hose (18) is closed.

32. The process according to claim 31, wherein the fluid is compressed air, which is introduced into the thick matter delivery pipe (10) via a compressor.

33. The process according to claim 31, wherein the fluid is water, which is introduced into a thick matter delivery pipe (10) via a water pump.

34. The process according to claim 31, wherein the cleaning body (22) is introduced via a slide valve (20) provided at the inlet side of the thick matter delivery pipe (10).

35. The process according to claim 32, wherein the sensor (26) recognizes at least two different predetermined material consistencies.

36. The process according to claim 31, wherein the sensor (26) impinges the thick matter delivery line (10) with ultrasound and determines the material consistency by evaluation of the reflected ultrasound.

37. A squeeze valve insertable upon an end-hose (18) of a thick matter delivery line (10) having an end-hose (18), the end-hose (18) including a jacket pipe of elastomeric material, the squeeze valve adapted for the at least partial closure of the end-hose (18) by narrowing the internal width of or for closing the end-hose (18) upon detection of a change in consistency of the material situated in a section of the thick matter delivery pipe (10), wherein said squeeze valve includes a hose (34) of an elastomeric material enclosing a ring-shaped hollow space (36), which hose (34) includes an inlet and outlet opening (40) for filling and emptying the hollow space (36) with a gas under pressure, and a ring-shaped jacket (44) receiving the hose (34) on its inside, which jacket prevents expansion of the hose in the radially outwards direction.

38. The squeeze valve according to claim 37, wherein the hose (34) is covered on its outer side, opposite the hollow space (36), with a textile fabric layer (38).

39. The squeeze valve according to claim 37, wherein the hose (34) is embedded in a sleeve (32) of elastomeric material.

40. The squeeze valve according to claim 39, wherein the sleeve (32) surrounds the jacket (44).

41. The squeeze valve according to claim 39, wherein the sleeve (32) has the shape of a hollow cylinder and that its inner diameter is at least as large as the outer diameter of the pipeline.

42. The squeeze valve according to claim 37, wherein the jacket (44) is comprised of a preferably multi-layer textile or fabric.

43. The squeeze valve according to claim 37, wherein a valve (42) is provided in the inlet and outlet opening (40).

44. A squeeze valve insertable upon an end-hose (18) of a thick matter delivery line (10), said squeeze valve including
a hose (34) of an elastomeric material enclosing a ring-shaped hollow space (36), said hose (34) including an inlet and outlet opening (40) for filling and emptying the hollow space (36) with a gas under pressure, and
a ring-shaped jacket (44) receiving the hose (34) on its inside, which jacket prevents expansion of the hose in the radially outwards direction.

45. The squeeze valve according to claim 44, wherein the hose (34) is covered on its outer side, opposite the hollow space (36), with a fabric layer (38).

46. The squeeze valve according to claim 44, wherein the hose (34) is embedded in a sleeve (32) of elastomeric material.

47. The squeeze valve according to claim 44, wherein the sleeve (32) surrounds the jacket (44).

48. The squeeze valve according to claim 44, wherein the sleeve (32) has the shape of a hollow cylinder and that its inner diameter is at least as large as the outer diameter of the pipeline.

49. The squeeze valve according to claim 44, wherein the jacket (44) is comprised of a preferably multi-layer textile or fabric.

50. The squeeze valve according to claim 44, wherein a valve (42) is provided in the inlet and outlet opening (40).
